(19) United States
(12) Patent Application Publication
(10) Pub. No.: US 2002/0185916 A1
(43) Pub. Date: Dec. 12, 2002

(54) Apparatus for controlling power distribution to devices

(76) Inventors: Bruce Barton, Huntington, NY (US); Russell Barton, Northport, NY (US)

Correspondence Address: ILYA ZBOROVSKY, 6 Schoolhouse Way, Dix Hills, NY, 11746, US

(21) Appl. No.: 09/953,743

(22) Filed: Sep. 17, 2001

Related U.S. Application Data
(60) Provisional application No. 60/255,730, filed on Dec. 15, 2000.

(51) Int. Cl. H02J 1/00

(52) U.S. Cl. 307/38

(57) ABSTRACT

An apparatus for controlling a power distribution to devices has a power inlet to be connected to a power source, a primary power outlet to be connected to a primary device, at least one secondary power outlet to be connected to at least one secondary device, a sensing unit for sensing when a current level falls below a threshold in response to the primary device being turned off and when the current level raises above a threshold in response to the primary device being turned on, and an executing unit operatively connected with the sensing unit and operative for interrupting a power supply to the at least one secondary power outlet when the sensing means sense the current level below the threshold and supplying power to the at least one secondary power outlet when the sensing means sense the current level above the threshold correspondingly, the sensing unit being formed as a high frequency current sensing coil.

### BACKGROUND OF THE INVENTION

The present invention relates to an apparatus for controlling a distribution of power to devices, for example to a main device and at least one secondary device or a plurality of secondary devices.

More particularly, the present invention relates to the above mentioned apparatus formed as electrical power strips and power control sensors which can be used with new devices having two mode of operation, standby or off and full on, with the use of main devices or secondary devices.

One type of electrical distribution apparatus is the power strip or power control center, which generally comprises of a row of power outlets, switched or unswitched, to distribute power to a primary device and secondary device(s) from a standard outlet (e.g., wall outlet). Some power strips and control centers contain options like circuit breakers, fuses and/or surge protectors, for example.

In newer personal computers the system can turn itself off or on and is controlled by the operating system. During the system shutdown there is a delay in which the operator must wait for the system to finish before turning off the secondary device(s). Depending on the operating software and programs, this can be a long time. Using this invention, the user may leave after the shutdown is started. When the system finishes and switches off or to the standby mode, the secondary device(s) will be turned off. Also if the system is set to wake at a preset time and run a script, the computer will need the peripheral devices left on. When used in conjunction with this invention, the peripherals will remain off until the computer awakes.

When used with computer devices, each device is plugged into a separate outlet with the computer plugged into the main outlet. When the computer is turned on, the current level increases to a high enough level to turn on the secondary device(s). Other constant power outlets may also be included for wake up devices, such as modems capable of bringing the system out of standby mode.

U.S. Pat. No. 4,659,941 discloses a power strip where the main outlet current controls the secondary device(s), Here, the secondary switch and trigger device are the same. In this configuration, the main device must draw current at the start of each cycle of line power for the triac to trigger correctly. With high efficiency supplies, this is never the case because they only draw power during the peak voltage of the line power. So, when used with a PCT or newer video/audio equipment, the voltage to the secondary outlets will not be a sine wave like the voltage from the wall outlet. This waveform can damage the secondary device(s). The second problem is personal computers and newer video/audio equipment do not turn off completely, but remain in a standby mode so they can turn themselves on at a given or occurrence. Because of this, the secondary device(s) will never be turned off, defeating the purpose of the power strip's use.

U.S. Pat. No. 4,731,549 and U.S. Pat. No. 4,970,623 discloses methods for controlling secondary device(s). Both require internal power supplies and many components, making them too expensive for mass production and difficult to fit in a standard power strip.

### SUMMARY OF THE INVENTION

Accordingly, it is an object of the present invention to provide apparatus for controlling power distribution to devices which is a further improvement of the inventive apparatuses.

In keeping with these objects and with others which will become apparent hereinafter, one feature of present invention resides, briefly stated, in an apparatus which has a power inlet to be connected to a power source; a primary power outlet to be connected to a primary device; at least one secondary power outlet to be connected to at least one secondary device; sensing means for sensing when a current level falls below a threshold in response to the primary device being turned off and when the current level raises above a threshold in response to the primary device being turned on; and executing means operatively connected with said sensing means and operative for interrupting a power supply to said at least one secondary power outlet when said sensing means sense the current level below the threshold and supplying power to said at least one secondary power outlet when said sensing means sense the current level above the threshold correspondingly, said sensing means being formed as a high frequency current sensing coil.

The apparatus in accordance with the present invention can be formed as a specialized outlet strip that can be used for devices that incorporate high efficiency power supplies, such as but not limited to computers, monitors and home theater systems. The apparatus would automate the task of turning on and off the different accessories that are used with the associated primary or parent device.

The apparatus in accordance with the present invention has a simple design, low production costs, minimal number of parts. The current sensing circuit is an insulated detecting structure which reduces instances of failure and/or damage of misuse. It also eliminates heat buildup during use with high current devices on the main outlet. Therefore high current devices can be used for prolonged period of time without risk of burning.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing an apparatus for controlling power distribution to devices in accordance with one embodiment of the present invention;

FIG. 2 is a view showing an apparatus for controlling power distribution to devices in accordance with another embodiment of the present invention;

FIG. 3 is a view showing an apparatus for controlling power distribution to devices in accordance with still a further embodiment of the present invention;

FIG. 4 is a view showing an apparatus for controlling power distribution to devices in accordance with still a further embodiment of the present invention;

FIG. 5 is a view showing a diagram illustrating an initial idle stage or a low power stage of the inventive apparatus; and

FIG. 6 is a view showing a diagram illustrating an increased power at a primary power outlet of the inventive apparatus.

### DESCRIPTION OF THE PREFERRED EMBODIMENTS

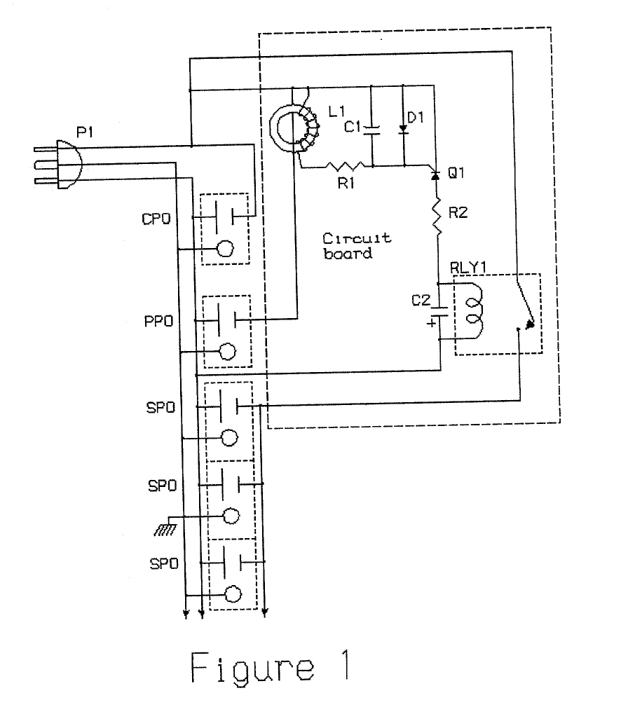

An apparatus for distributing power to devices, which is formed for example as a power strip is shown in accordance with one embodiment of the present invention in FIG. 1. It has a power inlet P1 which can be provided with a surge protection SP and is connectable to an AC power source. A main power outlet is identified as PPO and is provided for connecting a primary device, for example a computer. At least one and preferably a plurality of secondary power outlets are identified with reference numeral SPO and provided for connection of secondary devices, for example a computer associated accessories. A constant power outlet which is identified as CPO is used for connecting a device which must always have power and does not affect or is not affected by the other devices.

The apparatus further has current sensing means for sensing a current level, In particular, the current sensing means sense when a current level falls below a threshold in response to the primary device connected to the primary power outlet PPO being turned off, and when the current level raises above a threshold in response to the primary device being connected to the primary power outlet PPO being turned on. The sensing means includes a high frequency current sensing coil L1. It is wrapped around a wire which supplies power from the power inlet P1 to the primary power outlet PPO. It is used to convert a high frequency component of the current drawn for use from a high efficiency power supply to a voltage, to trigger the SCR Q1 as will be explained herein below. The high frequency current sensing coil can have a saturating core for limiting the voltage output of the high frequency current sensing coil.

The sensing means further includes the above mentioned SCR Q1. It provides power to executing means which will be also described herein below, when a current above a predetermined level is sensed on the primary power outlet. SCR Q1 is also used to rectify the power for the executing means, when an SCR or similar device is utilized.

The apparatus further has a resistor R1 which is arranged in series with the coil L1. A capacitor C1 is connected parallel to the resistor R1. The resistor Rl and the capacitor C1 form an RC time constant filter unit to prevent false triggering from line noise.

The apparatus further has a diode D1 which is arranged across the gate junction of the SCR Q1. The SCR Q1 uses only the positive voltage spikes and could be damaged by the negative going voltage spikes generated by the high frequency current sensing coil L1. The diode D1 is needed to absorb the negative going voltage spikes.

The apparatus further has the executing means which is formed for example as a relay RLY1. A resistor R2 is located in between the relay RLY1 and the SCR Q1. A capacitor C2 is located in parallel with the relay RLY1. The resistor R2 is used to drop the voltage to relay RLY1. The capacitor C2 is used to filter the voltage -to relay RLY1. Together they form an RC time constant which is used to filter out line noise and stop false triggering of relay RLY1. They also significantly reduce the chance of relay RLY1 from de-energizing from line noise.

While the power inlet, the primary power outlet and the secondary power outlets can be arranged separately, all other elements of the apparatus can be arranged on a common circuit board.

The apparatus in accordance with the present invention as shown in FIG. 1 operates in the following manner. During the initial idle stage the primary device is off or in a lower power state and the primary power outlet PPO draws less than ½ ampere which induces only a small voltage across the high frequency current sensing coil L1, as shown in FIG. 5. The small voltage would not be enough to turn on the SCR1. With the SCR Q1 off there will be no voltage applied to the resistor R2, the capacitor C2 and the relay RLY1 respectively. With the relay RLY1 de-energized, the contacts of the relay RLY1 will remain open, and the secondary power outlets SPO will remain off.

When the primary device is turned on, the current draw on the primary power outlet PPO will be greater than one ampere. But more importantly, the main primary or parent device, such as for example a computer, uses a high efficiency power supply draws current from the primary power outlet PPO, as shown in FIG. 6. High efficiency power supplies throw current only during the peaks of the incoming AC power. This current use produces fast rising leading edge with high frequency components in it. These rapid current changes produce a large enough voltage in the high frequency sensing coil L1 to turn on the SCR Q1 through the resistor R1. As mentioned, the resistor R1 together with the capacitor C1 form a circuit which prevents false triggering. Once the SCR Q1 is turned on, an AC voltage is applied to the relay R1 through the resistor R2. This voltage was rectified by SCR Q1 and filtered into a DC voltage using capacitor C2. This DC voltage is applied to the relay RLY1 thus energizing the relay and closing the contact. The secondary power outlets SPO are now energized, and also the secondary devices are successively are automatically turned on with the primary device.

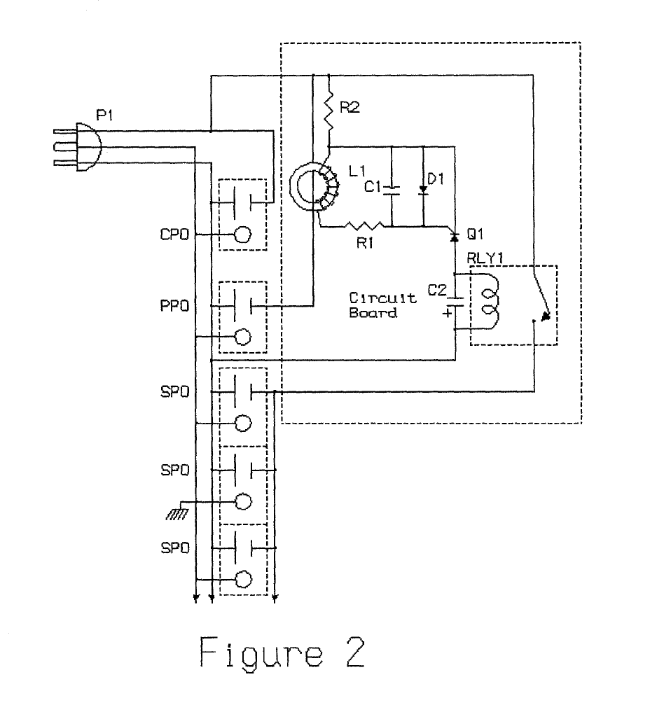

The apparatus in accordance with the second embodiment shown in FIG. 2 is substantially similar to the apparatus of the first embodiment shown in FIG. 1. However, in the apparatus in accordance with the second embodiment the current limiting resistor R2 has been moved. While in the embodiment of FIG. 1 the voltage dropping resistor R2 is connected between the SCR Q1 and the capacitor C2 connected with the relay RLY1, in the embodiment of FIG. 2 the voltage dropping resistor R2 is located before the high frequency sensing coil L1 and limits the voltage to the latter.

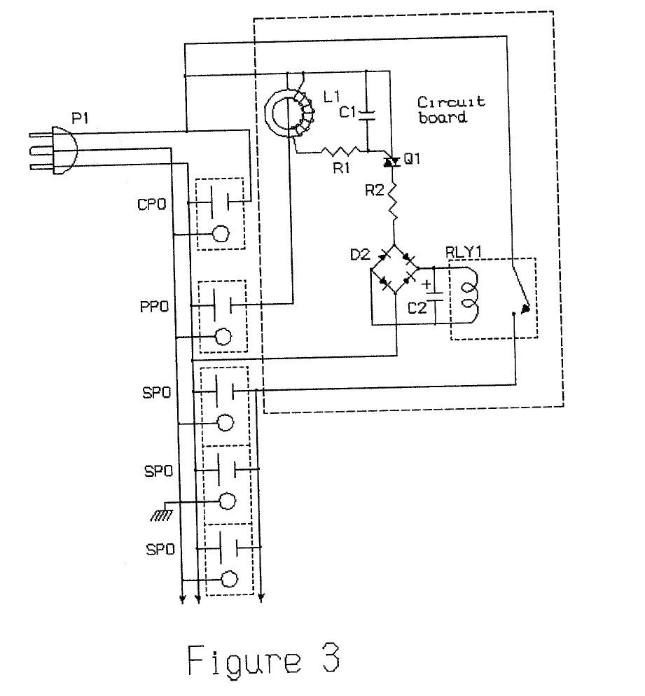

The apparatus in accordance with the third embodiment of the present invention is shown in FIG. 3. This apparatus is substantially similar to the apparatus of FIG. 1. However, in the apparatus in accordance with the embodiment shown in FIG. 3, the SCR Q1 of the apparatus of FIG. 1 is replaced with the triac Q1. The triac Q1 uses both the positive and negative voltage spikes generated by the high frequency current sensing coil L1. The diode D1 is not needed and is removed on FIG. 3. Since the triac Q1 of the embodiment of FIG. 3 does not rectify the AC voltage, diode bridge D2 of the embodiment of FIG. 3 is needed. The output of the triac Q1 is fed to the capacitor C2 and the relay RLY1 through the resistor R2 and the diode bridge D2.

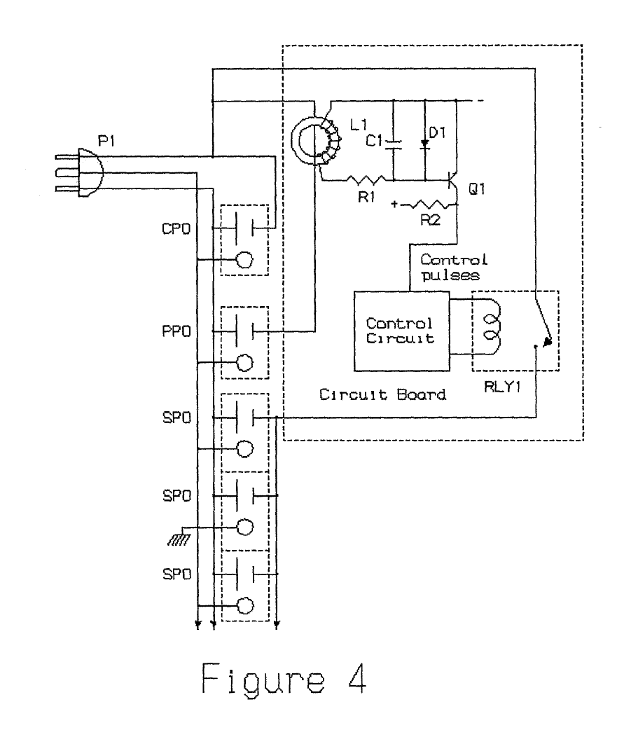

The apparatus in accordance with another embodiment of the present invention is shown in FIG. 4. In this embodiment the SCR Q1 is replaced with the transistor Q1. This would only create pulses on the collector of transistor Q1 rather than the latching effect of an SCR or triac. The pulses it would create would be detected by the control circuit shown in FIG. 4. The pulses would be used by the control circuit to latch relay RLY1. Voltage dropping resistor R2 would remain in series with the power source but the power source would need to be an external DC power source because an AC power source would damage the transistor Q1. Resistor R1, Capacitor C1 and Diode D1 would remain in the same configuration as in FIG. 1 and would serve the same purpose.

It will be understood that each of the elements described above, or two or more together, may also find a useful application in other types of constructions differing from the types described above.

While the invention has been illustrated and described as embodied in apparatus for controlling power distribution to devices, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. An apparatus for controlling a power distribution to devices, comprising a power inlet to be connected to a power source; a primary power outlet to be connected to a primary device, at least one secondary power outlet to be connected to at least one secondary device; sensing means for sensing when a current level falls below a threshold in response to the primary device being turned off and when the current level raises above a threshold in response to the primary device being turned on; and executing means operatively connected with said sensing means and operative for interrupting a power supply to said at least one secondary power outlet when said sensing means sense the current level below the threshold and supplying power to said at least one secondary power outlet when said sensing means senses the current level above the threshold correspondingly, said sensing means being formed as a high frequency current sensing coil.

2. An apparatus as defined in claim 1; and further comprising a wire which connects said power inlet with said primary power outlet so as to supply said primary current outlet with current, said high frequency current sensing coil being wrapped around said wire.

3. An apparatus as defined in claim 1, wherein said sensing means further include a SCR or triac connected with said high frequency current sensing coil so that, when said high frequency current sensing coil senses the, current level below the threshold said SCR or triac is turned off to interrupt current supply to said executing means and when said high frequency current sensing coil senses the current level above the threshold said SCR or triac is turned on and provides current supply to said executing means.

4. An apparatus as defined in claim 1; and further comprising means for limiting the voltage output of said high frequency current sensing coil and formed as a saturating core on the high frequency current sensing coil.

5. An apparatus as defined in claim 3; and further comprising means for preventing false triggering of said SCR or triac and including a resistor and a capacitor together forming an RC time constant or filter.

6. An apparatus as defined in claim 3; and further comprising means for protecting said SCR from a reverse voltage and including a diode.

7. An apparatus as defined in claim 3; and further comprising a resistor which connects said triac with said executive means, and a capacitor connected between said resistor and said executing means for filtering voltage applied to said resistor.

8. An apparatus as defined in claim 1, wherein said executing means is formed as a relay.

9. An apparatus as defined in claim 1; and further comprising a constant power outlet.
